(19) United States
(12) Patent Application Publication
(10) Pub. No.: US 2008/0150379 A1
(43) Pub. Date: Jun. 26, 2008

(54) VIBRATION MOTOR

(75) Inventors: Cheng-Fang Hsiao, Tu-Cheng (TW); Fong-Tan Yu, Tu-Cheng (TW); Ye-Fei Yu, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., TAIPEI HSIEN (TW)

(21) Appl. No.: 11/614,668

(22) Filed: Dec. 21, 2006

(51) Int. Cl. H02K 7/065

(52) U.S. Cl. 310/81

(57) ABSTRACT

A vibration stator includes a housing (30), a stator (10) received in the housing and a rotor (20) being rotatably disposed in the stator. The stator includes two claw-pole assemblies (11) arranged back-to-back and located at two opposite ends of the vibration motor symmetrically. Each claw-pole assembly includes two yokes (10a, 10b) each having a plurality of pole teeth (16a, 16b) extending therefrom and being intermeshed with those of the other yoke. The rotor includes a permanent magnet (26) and an eccentric weight (24) connected with the permanent magnet.

### BACKGROUND OF THE INVENTION

1. Field of the Invention

The present invention relates generally to a vibration motor, and more particularly to a vibration motor that is easily manufactured, and has a better vibration effect.

2. Description of Related Art

Mechanical vibrations are required for many different applications. Such as vibrations for material pulverization and selection in industrial use, vibration for home massage machines, and silent notification of incoming calls and messages for mobile phones, are but a few examples of mechanical vibration applications.

There are various methods that can be used to produce mechanical vibrations. One method involves the use of electric motors. A conventional type of vibration motor includes a housing receiving a stator therein, a bearing received in the stator, and a rotor being supported by the bearing. The rotor includes an output shaft being rotatably disposed in the bearing and extending through the housing, and an eccentric weight connected to the output shaft, which normally operates by rotating smoothly without any intention of vibration. Vibration is produced due to the eccentricity of the rotating part of the system as a result of the eccentric weight attached to the output shaft of the motor. However, the eccentric weight is external to the motor housing and thus the motor has multiple parts. This causes inconvenience in producing and assembly, and furthermore, the thickness and volume of the motor cannot be reduced easily. Such a bulky motor is disadvantageous in view of light, thin, small and compact requirement of the electronic products.

### SUMMARY OF THE INVENTION

According to a preferred embodiment of the present invention, a vibration motor includes a housing, a stator received in the housing, and a rotor being rotatably disposed in the stator. The stator includes two claw-pole assemblies arranged back-to-back and located at two opposite ends of the vibration motor symmetrically. Each claw-pole assembly includes a pair of yokes facing towards each other. A plurality of pole teeth extend from each of the yokes of each claw-pole assembly and are intermeshed with those of the other yoke to form a cylindrical-shaped sidewall for a coil wound therearound to generate an alternating magnetic field. The rotor includes a permanent magnet to generate a magnetic filed interacting with the alternating magnetic field generated by the pole teeth of the stator to drive the rotor into rotation, and an eccentric weight connected with the permanent magnet.

Other advantages and novel features of the present invention will be drawn from the following detailed description of a preferred embodiment of the present invention with attached drawings, in which:

### BRIEF DESCRIPTION OF THE DRAWINGS

Many aspects of the present vibration motor can be better understood with reference to the following drawings. The components in the drawings are not necessarily drawn to scale, the emphasis instead being placed upon clearly illustrating the principles of the present vibration motor. Moreover, in the drawings, like reference numerals designate corresponding parts throughout the several views:

FIG. 1 is an isometric, exploded view of a vibration motor in accordance with a preferred embodiment of the present invention;

FIG. 2 is an isometric, assembled view of the vibration motor of FIG. 1;

FIG. 3 an isometric, assembled view of a stator of the vibration motor of FIG. 2; and

FIG. 4 shows a cross-sectional view of the vibration motor of FIG. 2 taken along line III-III thereof.

### DETAILED DESCRIPTION OF THE INVENTION

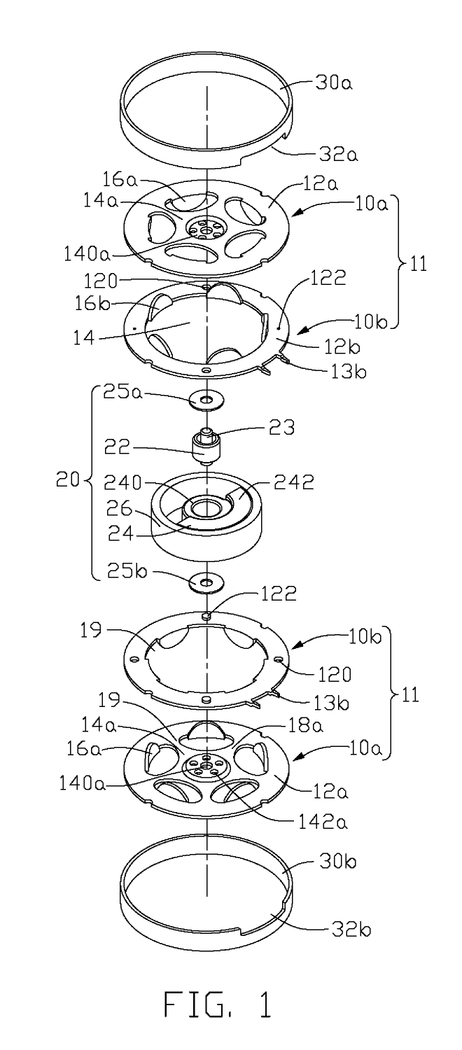

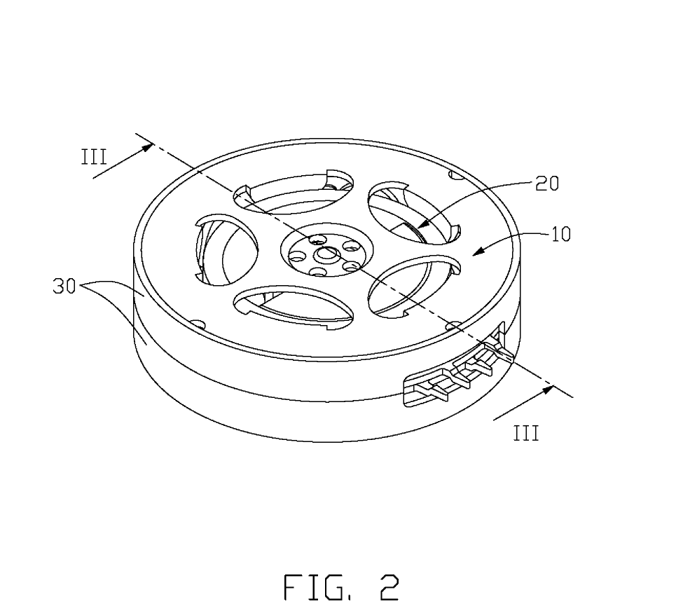

Referring to FIGS. 1-2, a vibration motor according to a preferred embodiment can be used in a communication equipment, such as a calling machine, a mobile phone or the like, which includes a housing 30, a stator 10 received in the housing 30, and a rotor 20 being rotatably supported by the stator 10.

The housing 30 is cylindrical-shaped, including a lower portion 30b and an upper portion 30a located above and facing the lower portion 30b. Alternatively the housing 30 can be integrally formed. Each of the lower and upper portions 30a, 30b defines a cutout 32a, 32b in a free end thereof. When assembled the free ends of the two portions 30a, 30b abut against each other, and cooperatively the cutouts 32a, 32b define a passage in the housing 30 for connecting the motor with a power source (not shown). It is to be understood that the passage can be only formed in one portion 30a, 30b of the housing 30 according to the shape of the stator 10 for conveniently connecting the motor to the power source.

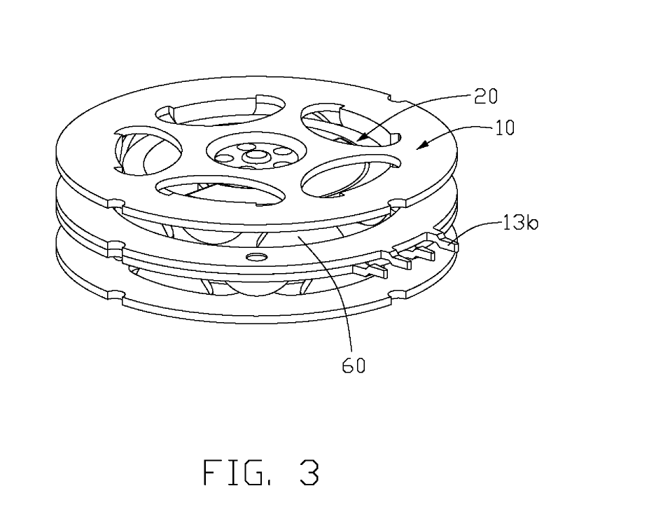

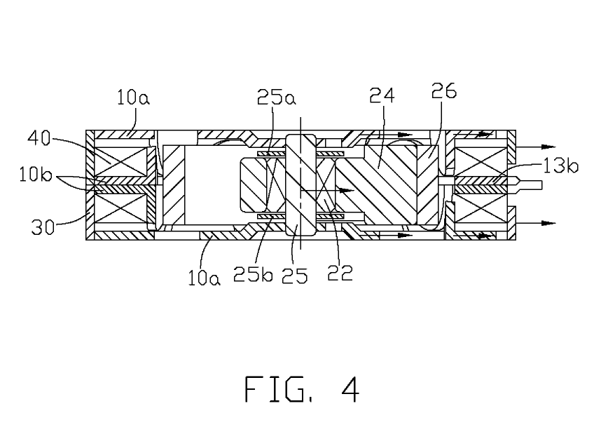

Also referring to FIGS. 3-4, the stator 10 includes upper and lower claw-pole assemblies 11 having size and shape the same with each other. Each of the claw-pole assemblies 11 includes an outer yoke 10a and an inner yoke 10b facing towards each other. Each of the inner yokes 10b of the claw-pole assemblies 11 is ring-shaped with a circular hole 14 defined therein. A plurality of pole teeth 16a, 16b extend perpendicularly from an inner circumference of each yoke 10a, 10b. Each tooth 16a, 16b forms an arc-shaped free end. In this embodiment, each yoke 10a, 10b forms five teeth 16a, 16b. It is to be understood that the number of the teeth 16a, 16b formed on the yokes 10a, 10b is decided by the precision requirement of the motor, being not limited to the disclosed embodiment. The pole teeth 16a, 16b of the yokes 10a, 10b are evenly spaced from each other along a circumferential direction thereof and thus define a plurality of slots 19 therebetween. Each pole tooth 16a, 16b has a shape and size the same as those of other teeth 16a, 16b. Each of the slots 19 has a size a little larger than that of the tooth 16a, 16b so as to receive a corresponding tooth 16a, 16b therein when the outer and inner yokes 10a, 10b are assembled together.

A circular-shaped mounting portion 14a is formed at a central portion of each of the outer yokes 10a. Five ribs 18a extend outwardly and radially from each mounting portion 14a to connect the mounting portion 14a with a periphery 12a of the outer yoke 10a. The ribs 18a are evenly spaced from each other along a circumferential direction of the mounting portion 14a and are connected with the periphery 12a of the outer yoke 10a between each two neighboring teeth 16a. The mounting portion 14a has an axis coincidental with that of the outer yoke 10a. A through hole 140a is defined in the mounting portion 14a with an axis coincidental with the axis of the mounting portion 14a. Several mounting holes 142a are defined in the mounting portion 14a around the through hole 140a. The mounting holes 142a are evenly spaced from each other along the circumferential direction of the mounting portion 14a.

The inner yoke 10b of each claw-pole assembly 11 forms two opposite apertures 120 therein, and a pair of opposite protrusions 122 thereon. Each protrusion 122 is spaced from a neighboring aperture 120 with 90 degrees. The protrusions 122 of the upper inner yoke 10b project therefrom downwardly, while the protrusions 122 of the lower inner yoke 10b project therefrom upwardly. The apertures 120 and the protrusions 122 are alternatively arranged and evenly spaced from each other along the circumferential direction of the inner yokes 10a. A pair of pins 13b are integrally formed with and extend outwardly from an outer periphery of each inner yoke 10b. The two pins 13b of each inner yoke 10b are spaced from and parallel to each other.

Each of the outer yokes 10a combines with a corresponding inner yoke 10b to form a claw-pole assembly 11. The inner yoke 10b and the outer yoke 10a of each claw-pole assembly 11 face to each other. The teeth 16a of each outer yoke 10a insert into the slots 19 of the corresponding inner yoke 10b. The teeth 16b of each inner yoke 10b insert into the slots 19 of the corresponding outer yoke 10a. Thus the pole teeth 16a, 16b of the two yokes 10a, 10b of each claw-pole assembly 11 are intermeshed with each other. Along the circumferential direction, the teeth 16a, 16b of the outer and inner yokes 10a, 10b of the claw-pole assembly 11 are arranged alternatively, and are separated from each other by an electrical angle of 180°. The teeth 16a, 16b of the yokes 10a, 10b of the claw-pole assembly 11 cooperatively form a cylindrical-shaped sidewall 60. The outer and inner yokes 10b are located at two opposite ends of the sidewall 60. A narrow gap is defined between each two neighboring pole teeth 16a, 16b of the sidewalls 60 for the relatively larger size of the slots 19 than the teeth 16a, 16b. The gaps between the teeth 16a, 16b are filled with resin inserted through the mounting holes 142a of the mounting portions 14a of the outer yokes 10a by insert molding, and thus fixedly combining the inner and outer yokes 10a, 10b together to form the claw-pole assembly 11.

The two claw-pole assemblies 11 are then arranged back-to-back to form the stator 10 of the motor. The circular holes 14 of the inner yokes 10b cooperatively define a space receiving the rotor 20 therein. The two claw-pole assemblies 11 are located at two opposite upper and lower ends of the motor symmetrically. The inner yokes 10b of the two claw-pole assemblies 11 abut each other and are located approximately in a middle of the stator 10. The protrusions 122 of each inner yoke 10b extend into the apertures 120 of the other inner yoke 10b to fixedly assemble the two claw-pole assemblies together. The outer yokes 10a of the two claw-pole assemblies 11 are spaced from each other. The outer yoke 10a of the upper claw-pole assembly 11 is located at a top end of the stator 10, whilst the outer yoke 10a of the lower claw-pole assembly 11 is located at a bottom end of the stator 10. A shaft 23 is received in the space of the stator 10 with top and bottom ends thereof being fixedly received in the through holes 140a of the outer yokes 10a of the claw-pole assemblies 11. An axis of the shaft 23 is coincidental with that of the stator 10.

The rotor 20 includes a bearing 22 mounted around the shaft 23, a permanent magnet 26 mounted around the bearing 22, and an eccentric block 24. The bearing 22 is an oil-retaining bearing, and being received in the space of the stator 10 and located between the mounting portions 14a of the outer yokes 10a. The bearing 22 has a height smaller than a distance between the two outer yokes 10a. Narrow gaps (not labeled) are defined between the bearing 22 and the outer yokes 10a. A pair of spacers 25a, 25b made of high abrasion resistant material are respectively received in the gaps and arranged on top and bottom ends of the bearing 22 for avoiding friction or impact between the bearing 22 and the outer yokes 10a during rotation of the rotor 20. The permanent magnet 26 is ring-shaped, and is received in the space of the rotor 20. An outer diameter of the magnet 26 is approximately the same or a little smaller than an inner diameter of the stator 10. The eccentric block 24 is sandwiched between the magnet 26 and the bearing 22, including a cylinder 240 mounted around the bearing 22 through interference and a weight 242 integrally formed with the cylinder 240. The weight 242 is substantially a semi-cylinder. An outer surface of the weight 242 is adhered to an inner surface of the magnet 26 by adhesive. Thus the bearing 22, the magnet 26 and the eccentric block 24 are fixedly assembled together.

During assembly, the rotor 20 and the stator 10 are received in the housing 30. The two claw-pole assemblies 11 are separated from each other by an electrical angle of 90°. The pins 13b of the two inner yokes 10b are alternatively arranged; one pin 13b of each inner yoke 10b is located between the two pins 13b of the other inner yoke 10b. The four pins 13b are parallel to each other and located at a same plane. Two coils 40 respectively wind around the sidewalls 60. The coils 40 each have two ends connected to the two pins 13b of a corresponding inner yoke 10b to be electrically connected to the power source. The rotor 20 is loosely and rotatably mounted around the shaft 23.

During operation, currents are applied to the coils 40 by the power source. An alternating magnetic field is thus generated to interact with the magnetic field established by the permanent magnet 26 to drive the rotor 20 of the motor into rotation. As the weight 242 of the eccentric block 24 is semi-cylindrical shaped, a center of gravity of the rotor 20 is offset from an axis of rotation, thereby vibration is produced due to the eccentricity of the rotor 20. As the claw-pole assemblies 11 of the stator 10 have the same shape and size and are arranged symmetrically, the elements of the stator 10 are easily to be formed and assembled. The eccentric block 24 of the rotor 20 is located in the space of the stator 10, thus the thickness and volume of the motor can be greatly reduced. Accordingly, an improved miniature vibration motor is obtained in accordance with the present invention.

In the motor in accordance with the present invention, the bearing 22 of the rotor 20 is rotated relative to the shaft 23, and the two ends the of the shaft 23 are combined with the outer yokes 10a of the stator 10. Thus, when the rotor 20 is rotated, the center of gravity and the center of rotation of the rotor 20 are not aligned with each other, so that rotation of the rotor 20 forms an unbalanced vibration. Such unbalanced vibration is directly transmitted to the upper and lower claw-pole assemblies 11 of the stator 10 via the shaft 23 as shown by arrows of FIG. 4; thus, the miniature vibration motor in accordance with the present invention can have a better vibration effect.

It is understood that the invention may be embodied in other forms without departing from the spirit thereof. Thus, the present example and embodiment is to be considered in all respects as illustrative and not restrictive, and the invention is not to be limited to the details given herein.

1. A vibration motor, comprising:
a housing;
a stator received in the housing, comprising two claw-pole assemblies arranged back-to-back and located at two opposite ends of the vibration motor symmetrically, each claw-pole assembly comprising inner and outer yokes facing towards each other, a plurality of pole teeth extending from each of the yokes of each claw-pole assembly and being intermeshed with those of the other yoke to form a cylindrical-shaped sidewall for coils wound therearound to generate an alternating magnetic field, a mounting portion being formed in a center of each outer yoke and a plurality of ribs interconnecting the mounting portion and a periphery of the each outer yoke, the mounting portion defining a through hole and a plurality of mounting holes around the through hole, and gaps defined between each two neighboring pole teeth of the cylindrical-shaped sidewall being filled with resin inserted through the mounting holes by insert molding, thus fixedly combining the inner and outer yokes together to form the claw-pole assembly; and
a rotor being rotatably disposed in the stator, comprising a permanent magnet for generating a magnetic filed for interacting with the alternating magnetic field generated by the stator to drive the rotor into rotation, and an eccentric block of weight connected with the permanent magnet.

2-16. (canceled)
